(19) United States
(12) Patent Application Publication
(10) Pub. No.: US 2013/0247728 A1
(43) Pub. Date: Sep. 26, 2013

(54) OPTICAL FIBER CUTTER/COATING MATERIAL REMOVER APPARATUS AND METHOD OF CUTTING OPTICAL FIBER AND REMOVING COATING MATERIAL

(71) Applicant: ASAHI GLASS COMPANY, LIMITED, Tokyo (JP)

(72) Inventors: Minoru SEKINE, Tokyo (JP); Yuji Watanabe, Tokyo (JP); Yoshimi Iijima, Tokyo (JP)

(73) Assignee: ASAHI GLASS COMPANY, LIMITED, Tokyo (JP)

(21) Appl. No.: 13/795,359

(22) Filed: Mar. 12, 2013

(30) Foreign Application Priority Data
Mar. 21, 2012 (JP) 2012-064509

(51) Int. Cl. G02B 6/245; G02B 6/25

(52) U.S. Cl. CPC G02B 6/245; G02B 6/25
USPC 83/27; 83/150

(57) ABSTRACT

An optical fiber cutter/coating material remover apparatus includes an optical fiber cutter unit and a coating material remover unit, the apparatus being configured such that the end portion of the multi-core optical fiber is cut while the optical fiber cutter unit is apart from the coating material remover unit, the cut end portion of the multi-core optical fiber is inserted into the coating material remover unit by sliding the optical fiber cutter unit or the coating material remover unit so that the optical fiber cutter unit and the coating material remover unit are in contact with each other, and then the coating material is removed by sliding the optical fiber cutter unit or the coating material remover unit so that the optical fiber cutter unit is apart from the coating material remover unit.

### BACKGROUND OF THE INVENTION

1. Field of the Invention

The present invention relates to an optical fiber cutter/coating material remover apparatus and a method of cutting an optical fiber and removing a coating material.

2. Description of the Related Art

A communication network in which plural terminal devices or electronic devices such as a display device or the like are connected by a multi-core optical fiber has been structured. The multi-core optical fiber is a flat cable (which is also referred to as a “fiber ribbon”) in which plural (from 4 to 24, for example) core-wire fibers (cores) are aligned in a parallel relationship with each other on a plane so that the plural core-wire fibers can be connected at the same time. For connecting the multi-core optical fiber with an electronic device, each of the core-wire fibers is previously exposed for a predetermined length to be connected with connection terminals of the electronic device.

An apparatus is known in which a coating material of an optical fiber is supported by a holder member including a pair of V-shaped holders from a radius direction, subsequently, the coating material is cut by a pair of cutters, and then, the coating material is removed from the optical fiber by an aspiration force of an aspiration pipe (Patent Document 1, for example).

Further, when there is a defect or dirt at an end surface of a core-wire fiber of an optical fiber, diffusion of light occurs. Thus, before removing (cutting) the coating material of the optical fiber, it is necessary to cut the end surface of the core-wire fiber such that the surface roughness of the end surface is small enough for an allowable scattering loss. The cutting position of the coating material is determined to be at a predetermined length from the end surface of the core-wire fiber in relation to the connecter. Thus, the position of the cutter for the coating material is adjusted to be a predetermined distance from the end surface of the core-wire fiber in accordance with the cutting position of the coating material.

Conventionally, the end portion of the optical fiber (the end surfaces of the core-wire fibers) is previously cut by an optical fiber cutter apparatus, and then the end portion of the optical fiber is inserted into a coating material remover apparatus so that the coating material is to be cut. Thus, it is necessary to prepare both the optical fiber cutter apparatus and the coating material remover apparatus. Therefore, there is a problem that a working efficiency is lowered as it is necessary to insert the optical fiber and remove the cut portions in both the optical fiber cutter apparatus and the coating material remover apparatus.

Further, according to the structure disclosed in Patent Document 1, as the optical fiber is cut one by one, it is impossible to cut plural core-wire fibers aligned in a parallel relationship with each other of a multi-core optical fiber at once and further it takes a large amount of time to remove a coating material of the optical fiber.

### [Patent Document]

[Patent Document 1] Japanese Laid-open Patent Publication No. 2006-149082

### SUMMARY OF THE INVENTION

The present invention is made in light of the above problems, and provides an optical fiber cutter/coating material remover apparatus and a method of cutting an optical fiber and removing a coating material capable of solving the above problems.

According to an embodiment, there is provided an optical fiber cutter/coating material remover apparatus including an optical fiber cutter unit which cuts an end portion of a multi-core optical fiber held by an optical fiber holder to be a first predetermined length; a coating material remover unit which cuts a surface of a coating material of the multi-core optical fiber at a second predetermined length from the end portion to expose a core-wire fiber inserted in the coating material for the second predetermined length; a connecting portion which slidably connects the optical fiber cutter unit to the coating material remover unit with respect to the coating material remover unit, the optical fiber cutter/coating material remover apparatus being configured such that the end portion of the multi-core optical fiber is cut while the optical fiber cutter unit is apart from the coating material remover unit, the cut end portion of the multi-core optical fiber is inserted into the coating material remover unit by sliding the optical fiber cutter unit or the coating material remover unit so that the optical fiber cutter unit and the coating material remover unit are in contact with each other, and then the coating material is removed by sliding the optical fiber cutter unit or the coating material remover unit so that the optical fiber cutter unit is apart from the coating material remover unit.

According to another embodiment, there is provided a method of cutting an optical fiber and removing a coating material, including a first step in which an optical fiber holder holding an optical fiber is held by an optical fiber cutter unit; a second step in which the multi-core optical fiber exposed from an end surface of the optical fiber cutter unit is cut to be a first predetermined length by moving a cutter for optical fiber by pushing a pushing operation unit of the optical fiber cutter unit; a third step in which the cut end portion of the multi-core optical fiber is inserted into a coating material remover unit by sliding the optical fiber cutter unit or the coating material remover unit so that the optical fiber cutter unit and the coating material remover unit are in contact with each other; a fourth step in which a surface of the coating material is cut at a second predetermined length from the cut end portion by a cutter for coating material by closing a cover member of the coating material remover unit; and a fifth step in which the optical fiber cutter unit or the coating material remover unit is moved to be apart from each other while holding the optical fiber holder to remove the coating material.

### BRIEF DESCRIPTION OF THE DRAWINGS

Other objects, features and advantages of the present invention will become more apparent from the following detailed description when read in conjunction with the accompanying drawings.

FIG. 1 is a perspective view showing an example of a structure of an optical fiber cutter/coating material remover apparatus seen from a front and right side;

FIG. 2A is a perspective view showing an example of a structure of the optical fiber cutter/coating material remover apparatus into which a multi-core optical fiber is inserted seen from the front and right side;

FIG. 2B is a side view showing an example of a structure of an optical fiber holder when a cover is open;

FIG. 2C is a side view showing an example of a structure of the optical fiber holder when the cover is closed;

FIG. 3A is a side view showing an example of a structure of a coating material cutter mechanism of a coating material remover unit seen from a left side in FIG. 1;

FIG. 3B is an enlarged side view showing the attachment structure of an upper cutter for coating material and a lower cutter for coating material of the coating material remover unit;

FIG. 3C is an enlarged vertical cross-sectional view showing a multi-core optical fiber;

FIG. 4A is a vertical cross-sectional view showing inside of the optical fiber cutter/coating material remover apparatus before cutting an end portion of an optical fiber;

FIG. 4B is a block diagram showing an example of a heater temperature control unit;

FIG. 5 is a vertical cross-sectional view showing inside of the optical fiber cutter unit;

FIG. 6A is a side view showing a cutter attachment portion of the optical fiber cutter unit;

FIG. 6B is a front view showing the cutter attachment portion of the optical fiber cutter unit;

FIG. 7 is a front cross-sectional view showing the structure of the optical fiber cutter mechanism;

FIG. 8A is a vertical cross-sectional view showing the structure of the optical fiber cutter mechanism before an optical fiber cutting operation;

FIG. 8B is a vertical cross-sectional view of the optical fiber cutter mechanism before the cutting operation taken along an A-A line in FIG. 8A;

FIG. 9A is a vertical cross-sectional view showing the operation of the pushing operation unit when a pushing operation unit is pushed downward;

FIG. 9B is a vertical cross-sectional view showing the operation of the pushing operation unit when the pushing operation unit is pushed downward taken along a B-B line in FIG. 9A;

FIG. 9C is a vertical cross-sectional view showing the operation of the pushing operation unit when the pushing operation unit is further pushed to cut the optical fiber;

FIG. 9D is a vertical cross-sectional view showing the operation of the pushing operation unit when the pushing operation unit is further pushed to cut the optical fiber taken along a C-C line in FIG. 9C;

FIG. 10 is a vertical cross-sectional view showing a state of the optical fiber cutter unit and the coating material remover after cutting the optical fiber;

FIG. 11 is a vertical cross-sectional view showing a state of the optical fiber cutter unit and the coating material remover when cutting the coating material;

FIG. 12A is a perspective view showing a process of step 1 in which the optical fiber is cut;

FIG. 12B is a perspective view showing a process of step 2 in which the optical fiber is cut;

FIG. 12C is a perspective view showing a process of step 3 in which the optical fiber is cut;

FIG. 12D is a perspective view showing a process of step 4 in which the optical fiber is cut;

FIG. 12E is a perspective view showing a process of step 5 in which the coating material is cut;

FIG. 12F is a perspective view showing a process of step 6 in which the coating material is cut;

FIG. 12G is a perspective view showing a process of step 7 in which the coating material is cut;

FIG. 12H is a perspective view showing a process of step 8 in which the coating material is cut;

FIG. 12I is a perspective view showing a process of step 9 in which the coating material is cut; and

FIG. 12J is a perspective view showing a process of step 10 in which the coating material is cut.

Note that also arbitrary combinations of the above-described constituents, and any exchanges of expressions in the present invention, made among methods, devices and so forth, are valid as embodiments of the present invention.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### First Embodiment

### (Structure of Optical Fiber Cutter/Coating Material Remover Apparatus 10)

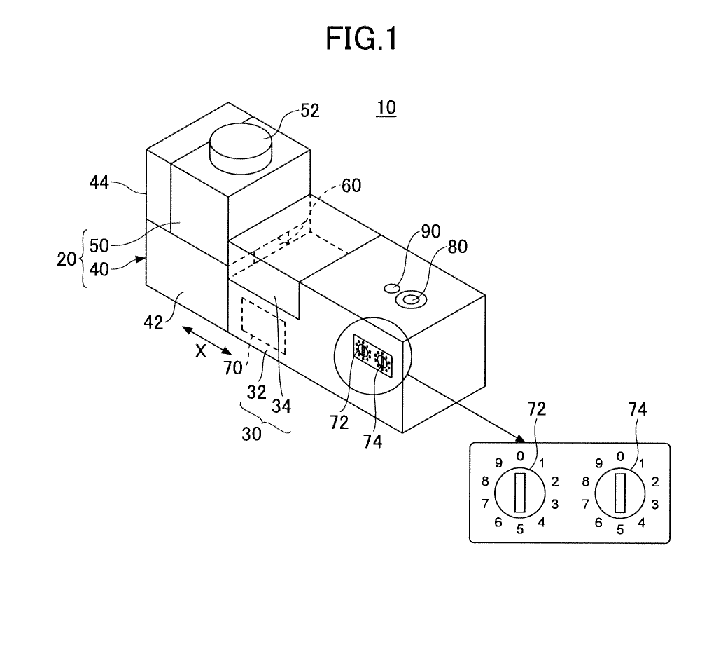

FIG. 1 is a perspective view showing an example of a structure of an optical fiber cutter/coating material remover apparatus 10 seen from a front and right side. As shown in FIG. 1, the optical fiber cutter/coating material remover apparatus 10 includes an optical fiber cutter unit 20 and a coating material remover unit 30. The optical fiber cutter unit 20 is provided at a left side of the apparatus 10 in FIG. 1 while the coating material remover unit 30 is provided at a right side of the apparatus 10. The optical fiber cutter unit 20 and the coating material remover unit 30 are slidably connected with each other in a horizontal direction (in an X-direction). As the optical fiber cutter/coating material remover apparatus 10 of the embodiment includes the optical fiber cutter unit 20 and the coating material remover unit 30 in a single apparatus, it is portable as well as the working efficiency becomes high. For example, when the optical fiber cutter unit and the coating material remover unit are separately provided in different apparatuses, if one of the apparatuses is lost, either of the optical fiber or the coating material cannot be cut and the optical fiber cannot be connected to a connector or the like. Therefore, it is always necessary to confirm that both of the apparatuses are prepared. However, according to the embodiment, as the optical fiber cutter unit 20 and the coating material remover unit 30 are integrally formed, there is no fear to forget to bring or prepare either of the optical fiber cutter unit 20 and the coating material remover unit 30. Further, cutting of an end surface of an optical fiber and removing of a coating material can be continuously performed so that the working efficiency is improved.

The optical fiber cutter unit 20 includes a holder supporting unit 40, an optical fiber cutter mechanism 50 and a pushing operation unit 52. The pushing operation unit 52 is provided at an upper surface of the optical fiber cutter mechanism 50 for cutting an end portion of a multi-core optical fiber.

The coating material remover unit 30 includes a housing 32, a cover member 34 and a coating material cutter mechanism 60 (expressed by a dotted line in FIG. 1). The coating material cutter mechanism 60 is provided at left-end surfaces of the housing 32 and the cover member 34. The coating material remover unit 30 further includes a heater unit 70 (expressed by a dotted line in FIG. 1), a time setting trimmer 72, a temperature setting trimmer 74, an operation switch 80 of the heater unit 70 and an indicating lamp (light emitting diode) 90.

The heater unit 70 is attached inside the housing 32. The time setting trimmer 72 and the temperature setting trimmer 74 are provided at a front surface of the housing 32 for setting the temperature and the period of the heater unit 70.

The time setting trimmer 72 is configured to be capable of setting arbitrary periods by rotating a handle of a dial. In this embodiment, graduation from 0 to 5 each of 5 seconds intervals is provided and it is possible to set 5 different periods indicated by the position of the handle of the dial from 5 seconds to 30 seconds (graduation of 6 to 9 are not used in this case). The temperature setting trimmer 74 is configured to be capable of setting arbitrary temperatures by rotating a handle of a dial. In this embodiment, graduation from 0 to 5 each of 10° C. intervals is provided and it is possible to set 5 different temperatures indicated by the position of the handle of the dial from 60° C. to 100° C. (graduation of 6 to 9 are not used in this case).

The operation switch 80 and the indicating lamp 90 are provided at an upper surface of the housing 32. The indicating lamp 90 is configured to emit a red light when the power is supplied to the heater unit 70 and keep emitting red light at an off-state before the operation switch 80 is pushed. Then, the indicating lamp 90 is configured to flash a red light when the operation switch 80 is pushed and emit a green light when the temperature of the heater unit 70 becomes a predetermined temperature. The temperature at which the indicating lamp 90 changes to emit a green light may be arbitrary set. For example, when the temperature is set to be 80° C., the indicating lamp 90 is set to emit a red light when the operation switch 80 is not pushed, flash the red light until the temperature of the heater unit 70 becomes 80° C. after the operation switch 80 is pushed, emit a green light when the temperature of the heater unit 70 becomes 80° C., flash the green light after a predetermined period set by the time setting trimmer 72 has passed until the temperature of the heater unit 70 becomes 80% of the set temperature, keep this status for about 1 minute, and then emit the red light and the heater unit 70 is automatically cooled.

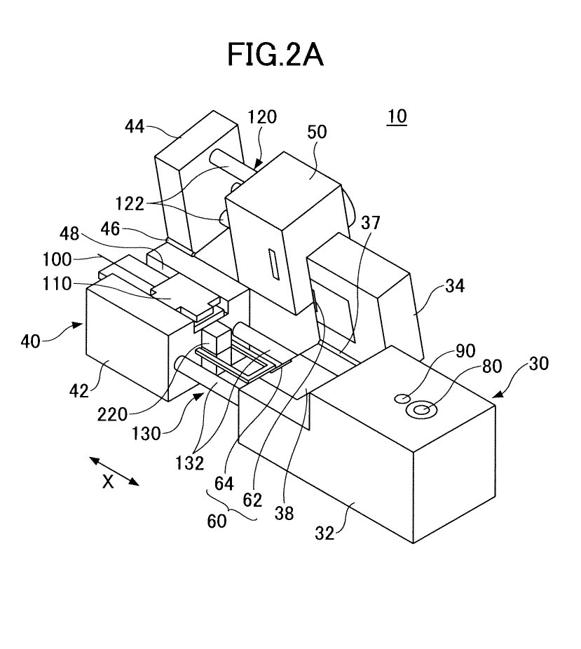

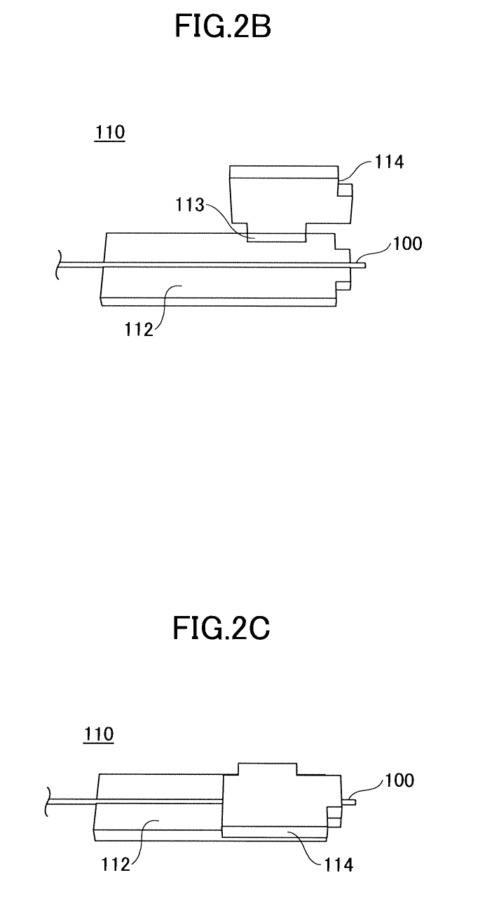

FIG. 2A is a perspective view of the optical fiber cutter/coating material remover apparatus 10 in which a multi-core optical fiber 100 is inserted seen from the front and right side. As shown in FIG. 2A, the holder supporting unit 40 of the optical fiber cutter unit 20 includes a lower holder 42 on which an optical fiber holder 110 of the multi-core optical fiber 100 is mounted and an upper holder 44 which holds an upper side surface of the optical fiber holder 110. The lower holder 42 is provided with a concave portion 48 with which the optical fiber holder 110 fits and is held at its upper surface.

The upper holder 44 is rotatably attached to the lower holder 42 by a hinge 46 at a backside surface of the lower holder 42 to be rotated backward with respect to the lower holder 42. The optical fiber cutter mechanism 50 is slidably attached to the upper holder 44 by a guide mechanism 120 including plural guide members 122 to be slid in the X-direction (a left-right direction in FIG. 2A) with respect to the upper holder 44. Thus, the optical fiber cutter mechanism 50 is rotated with the upper holder 44 when the upper holder 44 is rotated backward by the hinge 46.

The cover member 34 of the coating material remover unit 30 is also rotatably attached to the housing 32 by a hinge 37 at a backside surface of the housing 32 to be rotated backward with respect to the housing 32. The coating material cutter mechanism 60 includes an upper cutter for coating material 62 fixed at a left-end surface of the cover member 34 in order to cut the upper side of the coating material and a lower cutter for coating material 64 fixed at a left-end surface of the housing 32 in order to cut the lower side of the coating material. The coating material remover unit 30 includes a coating material remover 38 provided at the upper surface of the housing 32 to be covered or opened by the cover member 34.

The coating material remover unit 30 further includes a connection mechanism 130 (connecting portion) including a pair of guide members 132 provided at the side surface of the housing 32 and held between the lower holder 42 of the holder supporting unit 40. The guide member 132 has a structure including a combination of a major diameter pipe and a minor diameter pipe retractably provided. When the optical fiber cutter unit 20 and the coating material remover unit 30 are in contact as shown in FIG. 1, the guide members 132 are housed in either of the lower holder 42 of the holder supporting unit 40 and the housing 32 of the coating material remover unit 30. Then, when the optical fiber cutter unit 20 and the coating material remover unit 30 slid in a direction apart from each other, as shown in FIG. 2A, the retractably provided guide members 132 are pulled out and connect the optical fiber cutter unit 20 and the coating material remover unit 30.

### (Structure of Optical Fiber Holder 110)

FIG. 2B is a side view of the optical fiber holder 110 where a holder cover 114 is opened. As shown in FIG. 2B, the optical fiber holder 110 includes a holder base 112 provided with a groove in which the multi-core optical fiber 100 is to be mounted and the holder cover 114 which is opened and closed by a hinge 113 attached to a side surface of the holder base 112.

After mounting the multi-core optical fiber 100 on a center line of the holder base 112, as shown in FIG. 2C, the holder cover 114 is closed by being rotated so that the multi-core optical fiber 100 is held in the optical fiber holder 110. Here, the holder cover 114 is configured to engage with or is locked to the holder base 112 at a predetermined closing position in order not to open during the operation. The multi-core optical fiber 100 is held in the optical fiber holder 110 such that a predetermined length of the end portion is protruded from the end surface of the optical fiber holder 110.

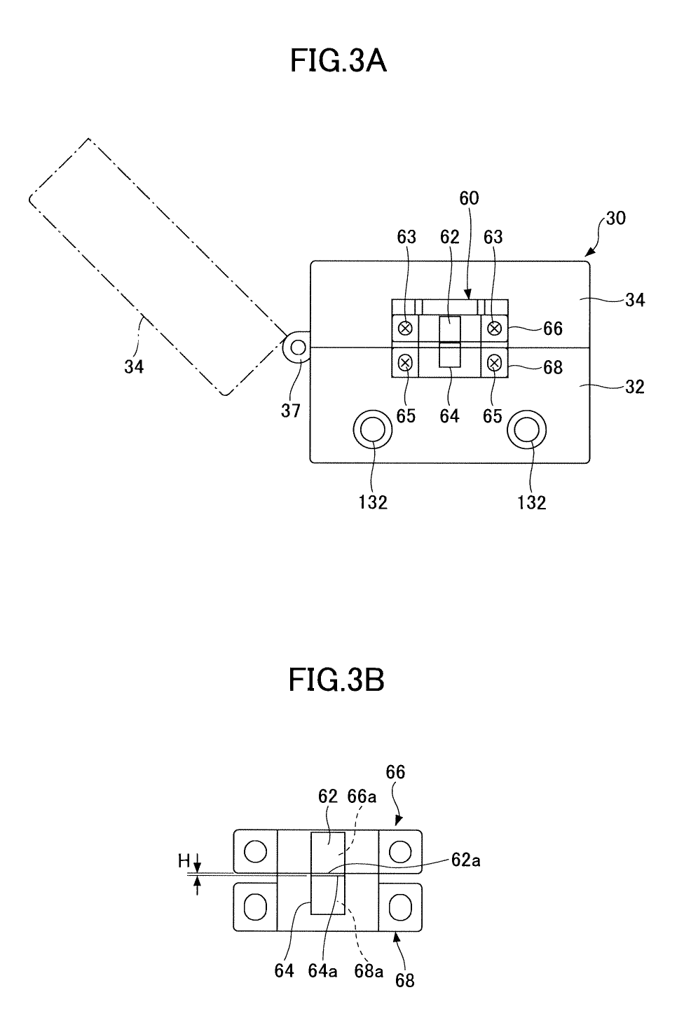

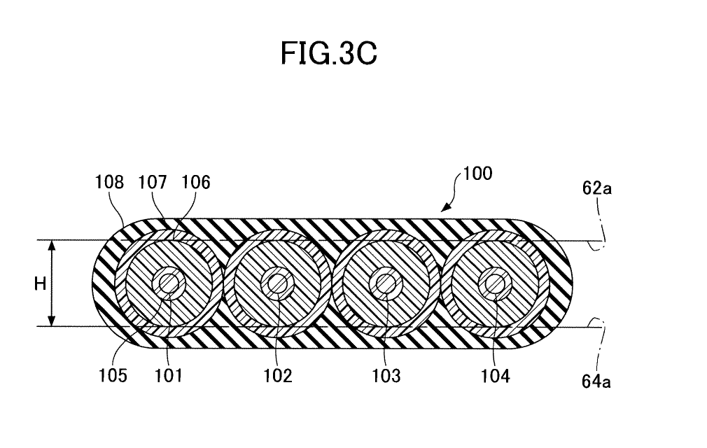

FIG. 3C is an enlarged vertical cross-sectional view showing an example of the multi-core optical fiber 100. As shown in FIG. 3C, when the multi-core optical fiber 100 is a four channel type, for example, the multi-core optical fiber 100 includes four core-wire fibers 101 to 104 aligned in a parallel relationship with each other. Each of the core-wire fibers 101 to 104 is surrounded by a clad 105 whose refraction index is different from the respective core-wire fiber 101 to 104 and further surrounded by coating materials 106 and 107 in this order toward outside. Then, the four core-wire fibers 101 to 104 each surrounded by the core 105, the coating materials 106 and 107 are further surrounded by a coating material 108. The coating materials 106 to 108 are made of UV curable resin, fire retarding material (inorganic filler) or the like. Thus, in this embodiment, each of the core-wire fibers 101 to 104 is coated by the three layers of coating materials 106 and 108. The coating materials 106 and 107 are formed to be concentric with the core-wire fibers 101 to 104 and the clads 105 which surround the core-wire fibers 101 to 104, respectively, and the coating material 108 is formed outside the coating materials 107 to surround the four fibers all together.

The diameter of each of the core-wire fibers 101 to 104 is 80±5 μm, and the diameters of the coating materials 106 and 107 are 200±5 μm and 250±5 μm, respectively, for example. The thickness of the multi-core optical fiber 100 is 0.30±0.005 mm, and the width of the multi-core optical fiber 100 is 1.1±0.2 mm, for example. Although the multi-core optical fiber 100 in which the four core-wire fibers are aligned in a parallel relationship with each other is exemplified in this embodiment, a multi-core optical fiber with plural core-wire fibers not limited to four may be used. For example, a multi-core optical fiber with plural core-wire fibers more than four (6, 8, 12, 24 or the like) may be used.

### (Coating Material Cutter Mechanism 60 of Coating Material Remover Unit 30)

FIG. 3A is a side view showing an example of the structure of the coating material cutter mechanism 60 of the coating material remover unit 30 seen from a left side in FIG. 1. As shown in FIG. 3A, the coating material cutter mechanism 60 of the coating material remover unit 30 includes the upper cutter for coating material 62 and the lower cutter for coating material 64. The upper cutter for coating material 62 is held by an upper attachment base 66 which is fixed to an end surface of the cover member 34 of the coating material remover unit 30 by screws 63 such that a blade directs downward. The lower cutter for coating material 64 is held by a lower attachment base 68 which is fixed to the housing 32 of the coating material remover unit 30 by screws 65 such that a blade directs upward.

The upper cutter for coating material 62 and the lower cutter for coating material 64 are attached such that the blades cut into the upper and lower surfaces of the multi-core optical fiber 100 when the cover member 34 is rotated to a cutting position where the cover member 34 faces the upper surface of the housing 32 (where the cover member 34 is closed).

FIG. 3B is an enlarged side view showing the attachment structure of the upper cutter for coating material 62 and the lower cutter for coating material 64 of the coating material remover unit 30. As shown in FIG. 3B, the upper attachment base 66 includes an attachment surface 66a at its center to which the upper cutter for coating material 62 is fixed. Similarly, the lower attachment base 68 includes an attachment surface 68a at its center to which the lower cutter for coating material 64 is fixed. Although not shown in the drawings, reference marks for adjusting attachment positions of parts are provided to the upper attachment base 66 and the lower attachment base 68. Then, by adjusting the positions based on the reference marks, there is provided a space H between the edge of the blade 62a of the upper cutter for coating material 62 and the edge of the blade 64a of the lower cutter for coating material 64. The space H is set in accordance with the diameters of the core-wire fiber 102, the clad 105 and the coating material 106 of the multi-core optical fiber 100. For example, two kinds of sets of the upper attachment base 66 and the lower attachment base 68 may be provided such that the space H become different values such as H=0.21 mm and H=0.22 mm, for example. As the space H is arbitrary set, the plural kinds of sets may be provided.

When cutting the coating materials 107 and 108, the coating material cutter mechanism 60 of the coating material remover unit 30 is used. At this time, in the coating material cutter mechanism 60, the blade 62a of the upper cutter for coating material 62 cuts into the upper coating materials 107 and 108 of the core-wire fibers 101 to 104 and the blade 64a of the lower cutter for coating material 64 cuts into the lower coating materials 107 and 108 of the core-wire fibers 101 to 104.

It means that the attachment positions of the upper cutter for coating material 62 and the lower cutter for coating material 64 are adjusted such that the space H between the blade 62a of the upper cutter for coating material 62 and the blade 64a of the lower cutter for coating material 64 becomes slightly larger than the diameters of the coating materials 106 of the core-wire fibers 101 to 104. Further, when cutting the coating materials 107 and 108, as will be described later, a second predetermined length of the coating materials 107 and 108 is removed by sliding the multi-core optical fiber 100 apart from the upper cutter for coating material 62 and the lower cutter for coating material 64 while having the coating materials 107 and 108 become softened by the heat of the heater unit 70.

(State of Apparatus before Cutting Optical Fiber)

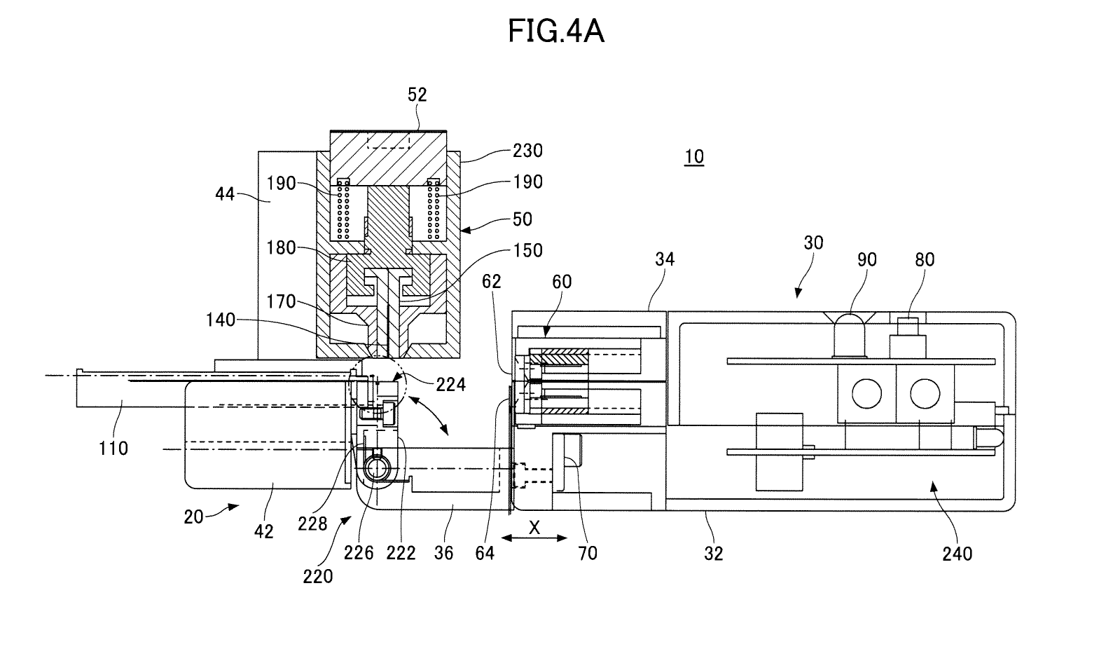

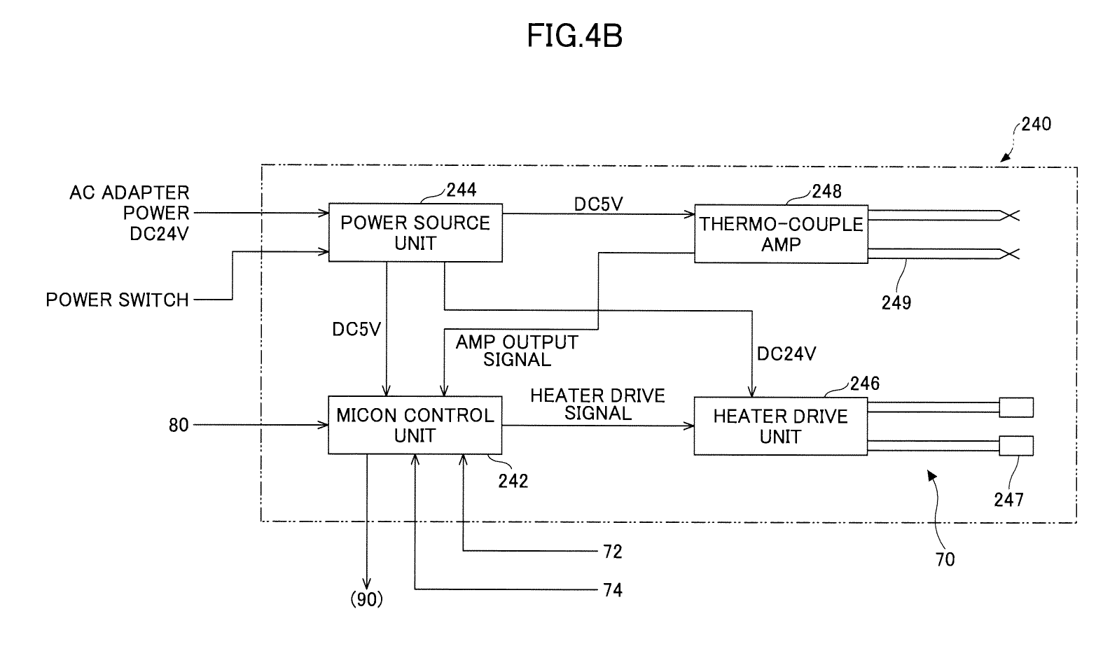

FIG. 4A is a vertical cross-sectional view showing inside of the optical fiber cutter/coating material remover apparatus 10 before cutting an end portion of an optical fiber.

When cutting the end portion of the multi-core optical fiber 100, it is important to cut the core-wire fibers 101 to 104 such that the cut surfaces become flat without defect in order to appropriately transmit the light within each of the core-wire fibers 101 to 104 (at a state that the surface roughness of the end surface is small enough for an allowable scattering loss). Thus, in the holder supporting unit 40, the optical fiber holder 110 is held between the lower holder 42 and the upper holder 44 and further, an optical fiber support mechanism 220 which supports a lower surface of the multi-core optical fiber 100 protruded from the end surface of the optical fiber holder 110 is provided below the optical fiber cutter mechanism 50.

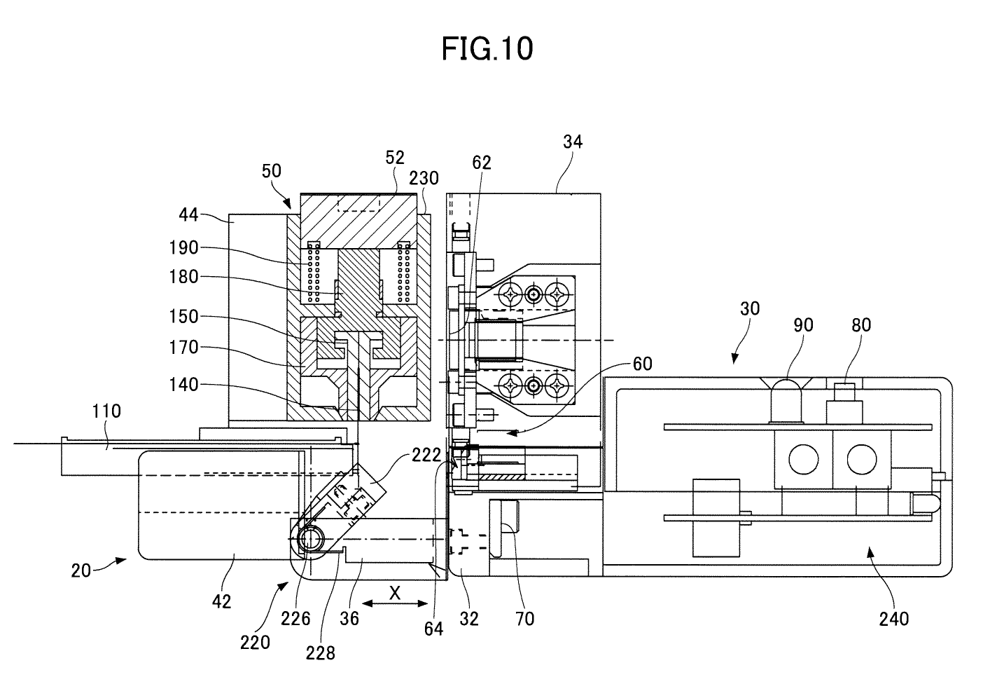

The optical fiber support mechanism 220 includes a movable support member 222 which is rotated to a position to contact the lower surface of the end portion of the multi-core optical fiber 100 when cutting the optical fiber. The movable support member 222 is supported by a support arm 36 which is formed to extend from the coating material remover unit 30 toward the optical fiber cutter unit 20 side. When the optical fiber cutter unit 20 is moved to an optical fiber cutting position (See FIG. 4A) at which the optical fiber cutter unit 20 is apart from the coating material remover unit 30, the movable support member 222 is maintained at a vertical state. On the other hand, when the optical fiber cutter unit 20 is moved to a coating material cutting position (see FIG. 10) at which the optical fiber cutter unit 20 contacts the coating material remover unit 30, the movable support member 222 is rotated in a clockwise direction to take a withdrawal position.

Further, a heater temperature control unit 240 which controls the temperature of the heater unit 70 to a desired temperature is provided in the housing 32 of the coating material remover unit 30. The heater temperature control unit 240 arbitrary sets the heating temperature (60° C. to 100° C., for example) and the heating period (5 second to 30 seconds, for example) of the heater unit 70 in accordance with the sets of the time setting trimmer 72 and the temperature setting trimmer 74 provided at the front surface of the housing 32 of the coating material remover unit 30.

FIG. 4B is a block diagram showing an example of the heater temperature control unit 240. As shown in FIG. 4B, the heater temperature control unit 240 includes a micon control unit 242, a power source unit 244, a heater drive unit 246, ceramics heaters 247, a thermo-couple AMP 248, and thermo-couples (temperature sensor) 249. The heater unit 70 is composed of the heater drive unit 246 and the ceramics heater 247.

When the operation switch 80 is switched on, the micon control unit 242 flows drive currents of predetermined voltages (DC 24V, DC 5V), respectively, from the power source unit 244 to the heater drive unit 246 and the thermo-couple AMP 248. With this, the heater drive unit 246 applies the drive current to the ceramics heater 247 to retain the ceramics heater 247 at a heating state.

The thermo-couple AMP 248 applies the drive current to the thermo-couple 249 to measure the temperature of the coating material remover 38 heated by the ceramics heater 247. The heating operation is continued until the temperature measured by the thermo-couple 249 reaches the temperature set by the temperature setting trimmer 74. Then, the micon control unit 242 controls to terminate the applying of the drive current to the heater drive unit 246 when the AMP output signal (measured temperature) output from the thermo-couple AMP 248 reaches the set temperature.

The micon control unit 242 outputs a signal to change the color of light to the indicating lamp 90 to have the indicating lamp 90 emit green light when the measured temperature by the thermo-couple AMP 248 reaches the set temperature.

### (Structure of Optical Fiber Cutter Mechanism 50 of Optical Fiber Cutter Unit 20)

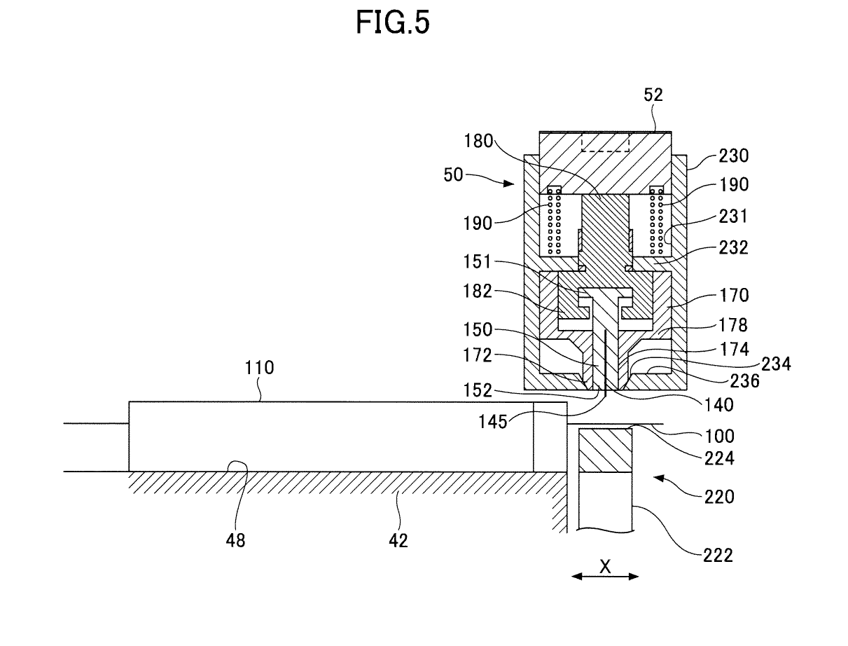

FIG. 5 is a vertical cross-sectional view showing an inside structure of the optical fiber cutter unit 20. As shown in FIG. 5, the optical fiber cutter mechanism 50 of the optical fiber cutter unit 20 is positioned above the optical fiber holder 110 which is mounted in the upper concave portion 48 of the lower holder 42. The movable support member 222 which supports the end portion of the multi-core optical fiber 100 protruded from the optical fiber holder 110 from the lower side is vertically positioned at the end surface of the lower holder 42 facing the coating material remover unit 30.

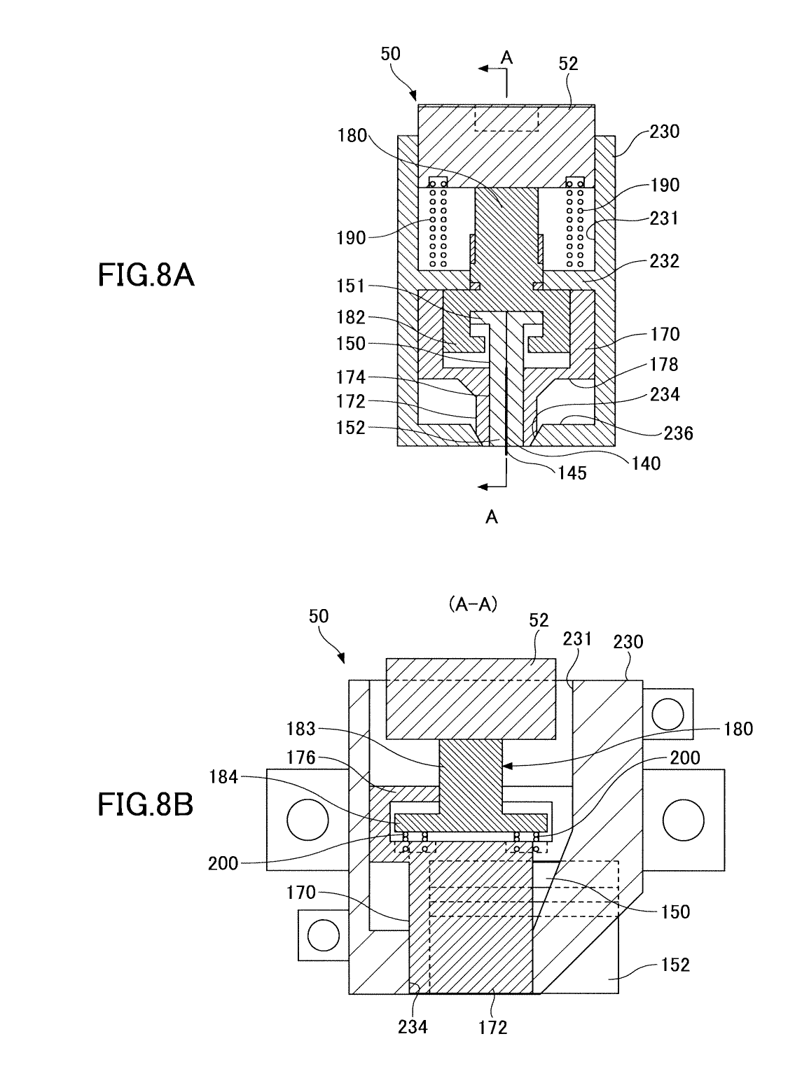

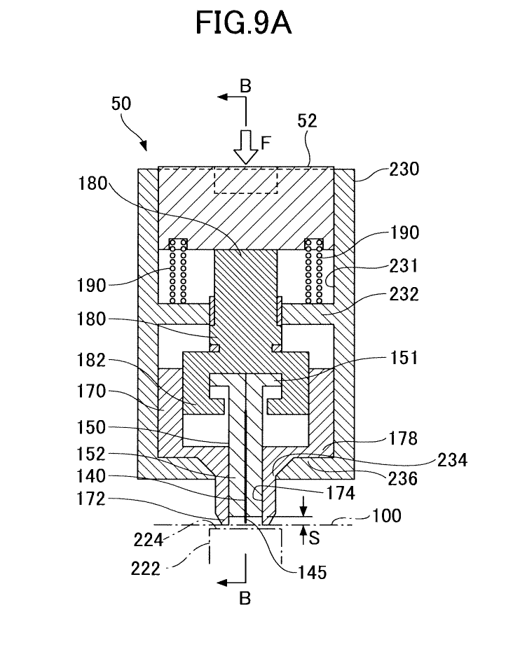

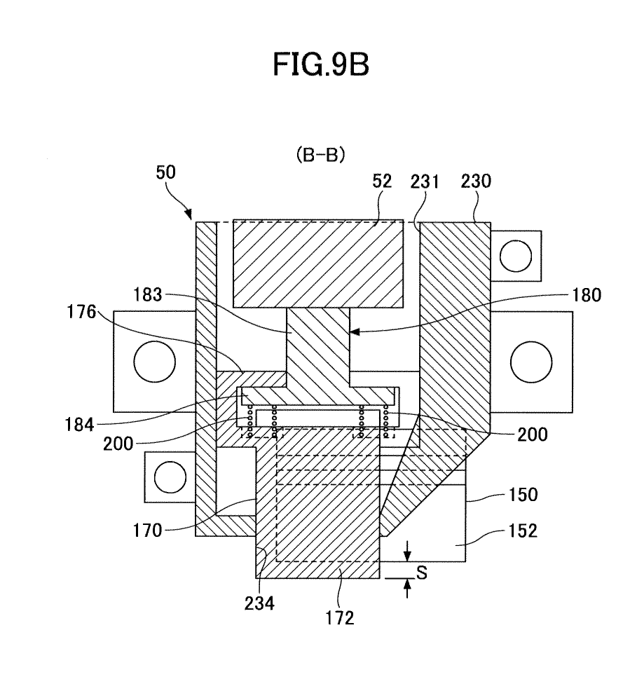

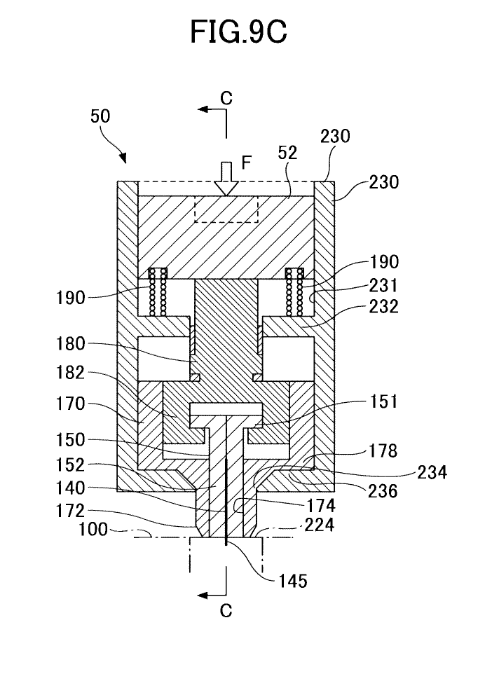

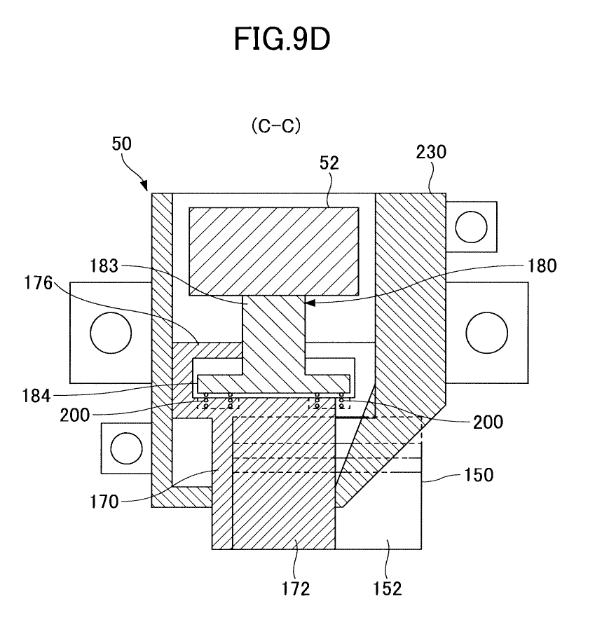

The optical fiber cutter mechanism 50 is housed in a cutter unit housing 230 and includes a column shaped pushing operation unit 52, a cutter support member 150 formed in a plate shape which supports a cutter for optical fiber 140, an optical fiber pressing member 170 provided outside of the cutter support member 150 and an elevating member 180 formed in a plate shape which connects the pushing operation unit 52 and the cutter support member 150. The optical fiber cutter mechanism 50 further includes a first spring member (a first elastic member) 190 which pushes the pushing operation unit 52 upward to recover to an initial position before the pushing operation and second a spring member (a second elastic member) 200 (see FIGS. 8B and 9B) which absorbs a relative displacement between the optical fiber pressing member 170 and the cutter for optical fiber 140 in accordance with a sliding operation of the elevating member 180. In this embodiment, a pair of the first spring members 190 and a pair of the second spring members 200 are respectively provided in directions perpendicular to each other in a plan view. Although the second spring members 200 are not shown in FIG. 4A, the second spring members 200 are shown in FIG. 8B and FIG. 9B.

In this embodiment, the diameters and the numbers of turns of the spring materials of the first spring member 190 and the second spring member 200 are configured such that the spring constant B1 of the first spring member 190 becomes smaller than the spring constant B2 of the second spring member 200 (B1<B2). Thus, the operation force F which is generated when the pushing operation unit 52 is pushed downward becomes larger than the spring force of the first spring member 190, the first spring members 190 are compressed, and when the operation force F is increased to be larger than the spring force of the second spring member 200, the second spring members 200 are compressed. By the difference of the spring forces between the first spring member 190 and the second spring member 200, the cutter support member 150 is further pushed to cut the end portion of the optical fiber 100 while the optical fiber 100 is being pressed by the optical fiber pressing member 170

A spring receiver 232 is provided at an inner wall 231 of the cutter unit housing 230 to which the lower ends of the first spring members 190 contact. The elevating member 180 is elevatably inserted inside the spring receiver 232. An engagement portion 182 of the elevating member 180 formed at the lower end and having a C-shape engages a collar portion 151 of the cutter support member 150.

When not being pushed, the pushing operation unit 52, the cutter support member 150 and the elevating member 180 are positioned at an upper side by the spring force of the first spring members 190 where the upper end of the pushing operation unit 52 protrudes from the upper opening of the cutter unit housing 230. The optical fiber pressing member 170 is positioned at the upper side with the elevating member 180. The cutter unit housing 230 is provided with an elongated opening 234 at its lower surface. The lower end 152 of the cutter support member 150 (the cutter for optical fiber 140) and the lower end 172 of the optical fiber pressing member 170 are inserted in the opening 234.

The cutter support member 150 is slidably inserted in the optical fiber pressing member 170 to be slidable in the upper and lower direction. The lower end 172 of the optical fiber pressing member 170 is provided with a guide hole 174 into which the lower end 152 of the cutter support member 150 is inserted. The lower end 152 of the cutter support member 150 which supports the cutter for optical fiber 140 is slidably guided in the vertical direction by the vertical inner wall of the guide hole 174.

### (Attachment Structure of Cutter for Optical Fiber 140)

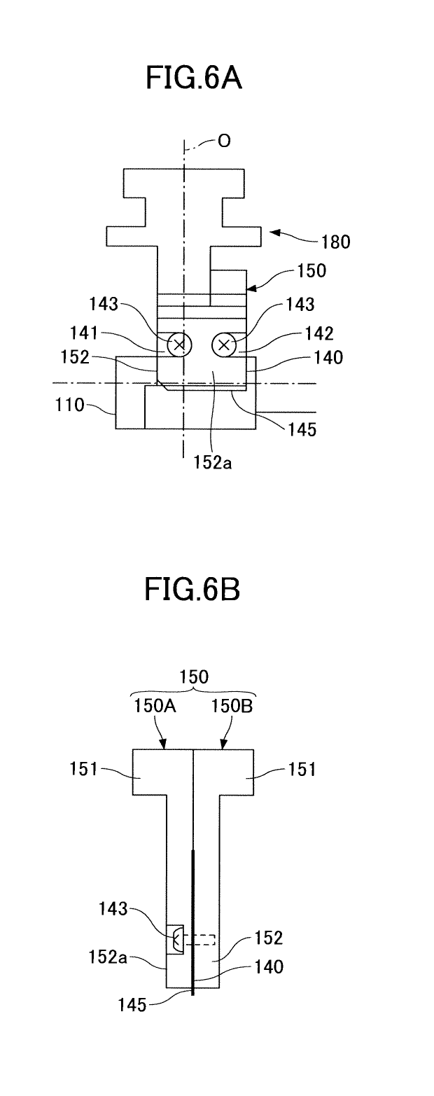

FIG. 6A is a side view showing a cutter attachment portion of the optical fiber cutter unit 20. FIG. 6B is a front view showing the cutter attachment portion of the optical fiber cutter unit 20. As shown in FIG. 6A and FIG. 6B, the cutter support member 150 includes a pair of support bodies 150A and 150B. The cutter for optical fiber 140 is inserted between lower ends 152a and 152 of the pair of support bodies 150A and 150B. The cutter for optical fiber 140 may be fixed by fixing the pair of support bodies 150A and 150B by a pair of fixed screws 143 or by a protruded portion provided at either of the pair of support bodies 150A and 150B.

In other words, the cutter for optical fiber 140 is inserted between and supported by the pair of support bodies 150A and 150B such that the blade 145 is exposed from the lower ends 152a and 152. With this structure, as the cutter for optical fiber 140 is stably fixed to the cutter support member 150 by the fastening force of the fixed screws 143, or fixed by the protruded portion provided at either of the pair of support bodies 150A and 150B, the cutter for optical fiber 140 is not inclined in the vertical direction or shifted in the front-back direction by the cutting operation. Further, by releasing the fixed screws 143 or by releasing from the pair of support bodies 150A and 150B, the cutter for optical fiber 140 can be easily exchanged.

Further, as shown in FIG. 6A, the cutter for optical fiber 140 is fixed in a shifted manner shifted from a center line O of the cutter support member 150 in the vertical direction toward the right side. Thus, only the left half of the blade 145, which is positioned at a cutting area, is used for cutting the optical fiber and the right half of the blade 145 is positioned at a non-cutting area. With this structure, even when the left half of the blade 145 is wasted, by detaching the cutter for optical fiber 140 by releasing the screws 143 and attaching the cutter for optical fiber 140 again after reversing, the left half of the blade 145, which is originally the right half the blade 145, can be used for cutting the optical fiber. Alternatively, by reversing the inserting direction of the cutter support member 150 to which the cutter for optical fiber 140 is fixed the originally right half of the blade 145 is positioned to be at the left side. With the above operation, the life time of the cutter for optical fiber 140 can be increased.

### (Cutting Operation of Cutting End Portion of Multi-Core Optical Fiber 100)

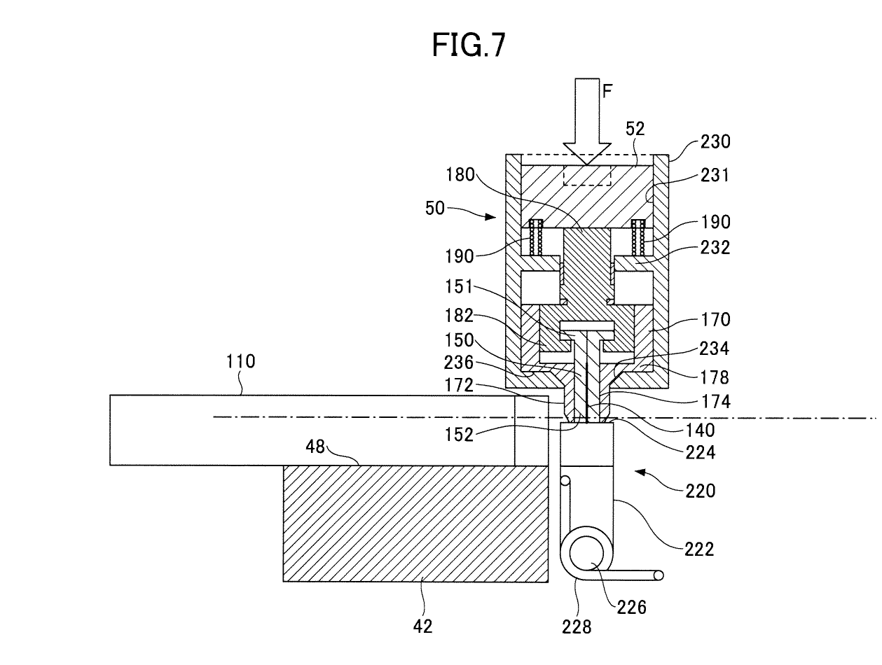

FIG. 7 is a front cross-sectional view showing the structure of the optical fiber cutter mechanism 50 for explaining the cutting operation of the optical fiber cutter mechanism 50. As shown in FIG. 7, when the pushing operation unit 52 of the optical fiber cutter mechanism 50 is pushed downward, the cutter support member 150 moves downward with the optical fiber pressing member 170 so that the lower end 172 of the optical fiber pressing member 170 presses the multi-core optical fiber 100 toward a contacting surface 224 of the movable support member 222. With this, the multi-core optical fiber 100 protruded from the end portion of the optical fiber holder 110 is inserted between the lower end 172 of the optical fiber pressing member 170 and the contacting surface 224 of the movable support member 222.

Here, when the pushing operation unit 52 is pushed downward, the elevating member 180 moves downward by the pushing force by the pushing operation unit 52 as well as the second spring members 200 (see FIG. 8B) push the optical fiber pressing member 170 downward. Thus, the optical fiber pressing member 170 moves downward with the cutter support member 150.

Further, when the downward movement of the optical fiber pressing member 170 is terminated as the lower end 172 of the optical fiber pressing member 170 contacts the upper surface of the multi-core optical fiber 100, and the pushing operation unit 52 is further pushed downward, the second spring members 200 (see FIG. 8B) are compressed so that the cutter support member 150 moves downward with respect to the optical fiber pressing member 170 to have the cutter for optical fiber 140 cut into the multi-core optical fiber 100.

When the lower ends 152a and 152 of the cutter support member 150 moves further downward while the multi-core optical fiber 100 is held by the optical fiber pressing member 170, the blade 145 of the cutter for optical fiber 140 reaches the contacting surface 224 of the movable support member 222 which is in contact with the lower surface of the multi-core optical fiber 100. With this, the end portion of the multi-core optical fiber 100 is cut at a first predetermined length from the end portion of the optical fiber holder 110.

Here, the optical fiber pressing member 170 does not move further downward when a step portion 178 provided above the lower end 172 contacts an inner wall 236 of the cutter unit housing 230. Thus, the inner wall 236 of the cutter unit housing 230 functions as a stopper which prevents application of an extremely large pushing force to the cutter for optical fiber 140 when cutting.

The movable support member 222 is supported by the end portion of the support arm 36 extended from the end surface of the coating material remover unit 30 toward the optical fiber cutter unit 20 side (see FIG. 4A). The movable support member 222 is rotatably supported by a shaft 226 provided near the end portion of the support arm 36. The movable support member 222 is pushed in an anti-clockwise direction by a spring force of a torsion spring 228 wound around the shaft 226. At this time, the movable support member 222 contacts the end surface of the lower holder 42 at the left-side surface (in FIG. 4A) and is vertically positioned so that the contacting surface 224 directs upward facing the cutter for optical fiber 140.

### (Operation of Optical Fiber Cutter Mechanism 50)

FIG. 8A is a vertical cross-sectional view showing the structure of the optical fiber cutter mechanism 50 before the optical fiber cutting operation. FIG. 8B is a vertical cross-sectional view taken along an A-A line in FIG. 8A showing the structure of the optical fiber cutter mechanism 50 before the optical fiber cutting operation.

As shown in FIG. 8A, before the optical fiber cutting operation, the pushing operation unit 52 is positioned above by the spring force of the first spring members 190. The cutter support member 150 and the optical fiber pressing member 170 are housed inside the cutter unit housing 230.

As shown in FIG. 8B, the elevating member 180 includes a plate sliding portion 183 provided between the pushing operation unit 52 and the cutter support member 150 and a collar portion 184 provided to be protruded from the front and back directions of the sliding portion 183 in addition to the engagement portion 182. The second spring members 200 are provided between the collar portion 184 of the elevating member 180 and the upper end of the optical fiber pressing member 170.

As shown in FIG. 8B, the optical fiber pressing member 170 includes an engagement portion 176 extending from the back side toward the upper direction and having a C-shape. The engagement portion 176 is formed to face the upper surface, the side surface and the lower surface of the collar portion 184 of the elevating member 180 with a predetermined space, respectively. The engagement portion 176 is pushed upward in accordance with the upward movement of the elevating member 180 when the pushing operation unit 52 is not pushed.

FIG. 9A is a vertical cross-sectional view showing the operation of the pushing operation unit 52 when the pushing operation unit 52 is pushed downward. FIG. 9B is a vertical cross-sectional view showing the cutting operation of the optical fiber cutter mechanism 50 taken along a B-B line in FIG. 9A.

As shown in FIG. 9A and FIG. 9B, when the pushing operation unit 52 is pushed downward by the operation force F, the optical fiber pressing member 170 and the cutter support member 150 are slid downward via the spring force of the pair of second spring members 200 in accordance with the downward movement of the elevating member 180.

With this, the lower end 172 of the optical fiber pressing member 170 protrudes from the lower side of the opening 234 at the lower surface of the cutter unit housing 230 to contact the upper surface of the multi-core optical fiber 100. At this time, the lower surface of the multi-core optical fiber 100 contacts the contacting surface 224 at the upper end of the movable support member 222. Thus, the multi-core optical fiber 100 is stably inserted between the lower end 172 of the optical fiber pressing member 170 and the contacting surface 224 at the upper end of the movable support member 222 without being shifted during the cutting operation.

Further, at this operation of holding the multi-core optical fiber 100, the cutter for optical fiber 140 fixed to the lower ends 152a and 152 of the cutter support member 150 is housed inside the guide hole 174 of the optical fiber pressing member 170 and is retracted for a distance S from the end surface of the lower end 172.

FIG. 9C is a vertical cross-sectional view showing the operation of the pushing operation unit 52 when the pushing operation unit 52 is further pushed to cut the optical fiber. FIG. 9D is a vertical cross-sectional view showing the operation of the pushing operation unit 52 when the pushing operation unit 52 is further pushed to cut the optical fiber taken along a C-C line in FIG. 9C.

As shown in FIG. 9C and FIG. 9D, when the pushing operation unit 52 is further strongly pushed downward, the step portion 178 of the optical fiber pressing member 170 contacts the inner wall 236 of the cutter unit housing 230 to terminate the movement of the optical fiber pressing member 170 while only the cutter support member 150 provided inside the optical fiber pressing member 170 moves downward. At this time, the lower ends 152a and 152 of the cutter support member 150 slid downward within the guide hole 174 of the optical fiber pressing member 170 for the distance S as the second spring members 200 are compressed. With this, the blade 145 of the cutter for optical fiber 140 (see FIG. 6B) fixed to the lower ends 152a and 152 of the cutter support member 150 protrudes from the lower side of the guide hole 174 to cut the end portion of the multi-core optical fiber 100 supported by the lower end 172 of the optical fiber pressing member 170 between the contacting surface 224 of the movable support member 222 at a first predetermined length from the end surface of the optical fiber holder 110.

Thereafter, by releasing the pushing force to the pushing operation unit 52 to have the operation force F become zero, the pushing operation unit 52 and the optical fiber pressing member 170 move upward with the cutter support member 150 by the spring force of the first spring members 190 to be the initial position before the so that the position (see FIG. 8A) before the pushing operation.

### (Cutting Operation of Coating Material of Multi-Core Optical Fiber 100)

FIG. 10 is a vertical cross-sectional view showing the structure of the optical fiber cutter unit 20 and the coating material remover unit 30 after cutting the optical fiber. As shown in FIG. 10, after the step of cutting the optical fiber is finished, the step of removing the coating material is performed in which the coating materials 107 and 108 of the multi-core optical fiber 100 are cut.

In the step of removing the coating material, the multi-core optical fiber 100 and the optical fiber holder 110 are kept being held by the holder supporting unit 40 of the optical fiber cutter unit 20, and with this state, the holder supporting unit 40 and the coating material remover unit 30 are slid to be closer to each other. At this time, at the coating material remover unit 30, the cover member 34 is opened with respect to the housing 32 (the cover member 34 is rotated backward for a predetermined angle to be inclined state) and thus the cut end portion of the multi-core optical fiber 100 does not contact the coating material cutter mechanism 60 of the coating material remover unit 30.

When the lower holder 42 is slid in the X-direction (right direction in FIG. 10), the lower holder 42 pushes the movable support member 222 in the sliding direction to rotate the movable support member 222 in the clockwise direction. With this operation, the movable support member 222 is housed in a concave portion of the support arm 36 and the support arm 36 is relatively housed in a concave portion provided at the lower side of the lower holder 42. Further, at this time, the optical fiber cutter mechanism 50 is also moved to be closer to the upper holder 44 of the holder supporting unit 40. The optical fiber cutter mechanism 50 may be pushed by the cover member 34 when the lower holder 42 is slid in the X-direction so that is moved toward the upper holder 44 at this time.

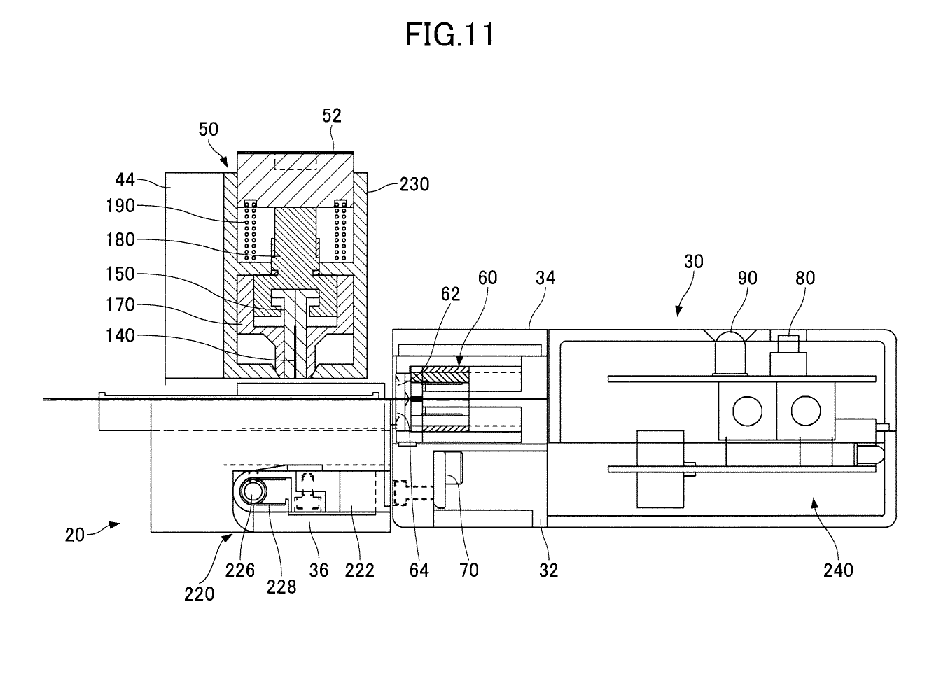

FIG. 11 is a vertical cross-sectional view showing the structure of the optical fiber cutter unit 20 and the coating material remover unit 30 when cutting the coating material. As shown in FIG. 11, when the optical fiber cutter unit 20 contacts the coating material remover unit 30, the cut end portion of the multi-core optical fiber 100 is inserted into the coating material cutter mechanism 60 above the lower cutter for coating material 64. Subsequently, the cover member 34 is rotated to be closed with respect to the housing 32 of the coating material remover unit 30. With this, in the coating material cutter mechanism 60, the upper cutter for coating material 62 and the lower cutter for coating material 64 become closer to each other to be a cutting position (see FIG. 3A). It means that the blade 62a of the upper cutter for coating material 62 and the blade 64a of the lower cutter for coating material 64 are positioned at the dotted lines 62a and 64a shown in FIG. 3C to be cut into predetermined depths of the coating materials 107 and 108 of the multi-core optical fiber 100 from the upper and lower directions, respectively. The predetermined depths are set not to cut the core-wire fibers 101 to 104, the clads 105 and the coating materials 106 of the multi-core optical fiber 100.

For parts of the coating materials 107 and 108 of the multi-core optical fiber 100 where the upper cutter for coating material 62 and the lower cutter for coating material 64 cannot cut, the coating materials 107 and 108 are heated by the heater unit 70 to be softened and at this state, the holder supporting unit 40 is slid to be apart from the coating material remover unit 30. It means that the holder supporting unit 40 pulls out the multi-core optical fiber 100 from the coating material cutter mechanism 60 while the blade 62a of the upper cutter for coating material 62 and the blade 64a of the lower cutter for coating material 64 are cut into the upper and lower surface of the coating materials 107 and 108 of the multi-core optical fiber 100.

Thus, the front ends of the coating materials 107 and 108 of the multi-core optical fiber 100 are removed as being torn apart from a position where the blade 62a of the upper cutter for coating material 62 and the blade 64a of the lower cutter for coating material 64 are cut into.

Therefore, at the end portion of the multi-core optical fiber 100 which is exposed from the end surface of the optical fiber holder 110 held by the holder supporting unit 40, a second predetermined length (which is shorter than the first predetermined length) of the coating materials 107 and 108 are removed and the core-wire fibers 101 to 104 (and the clads 105) coated by the coating material 106 are exposed.

### (Steps of Cutting Optical Fiber and Removing Coating Material)

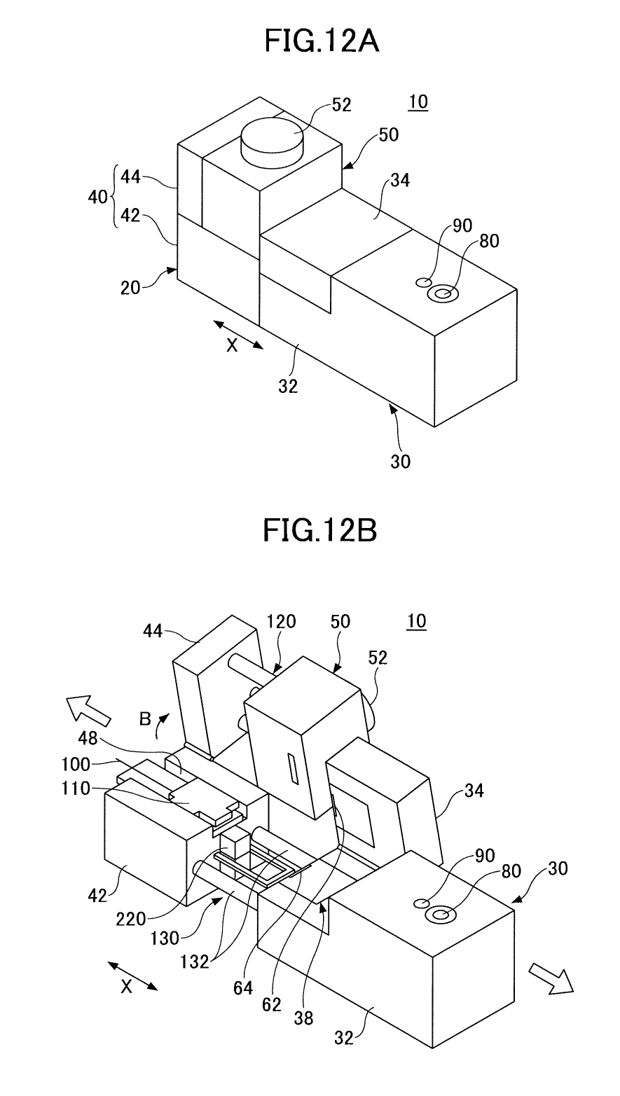

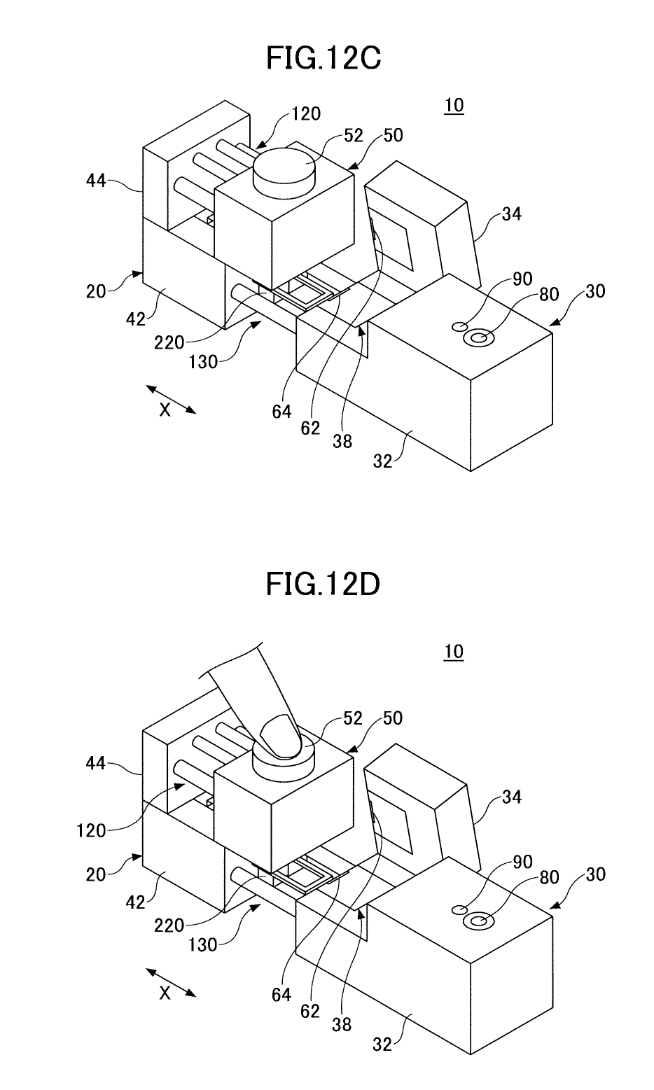

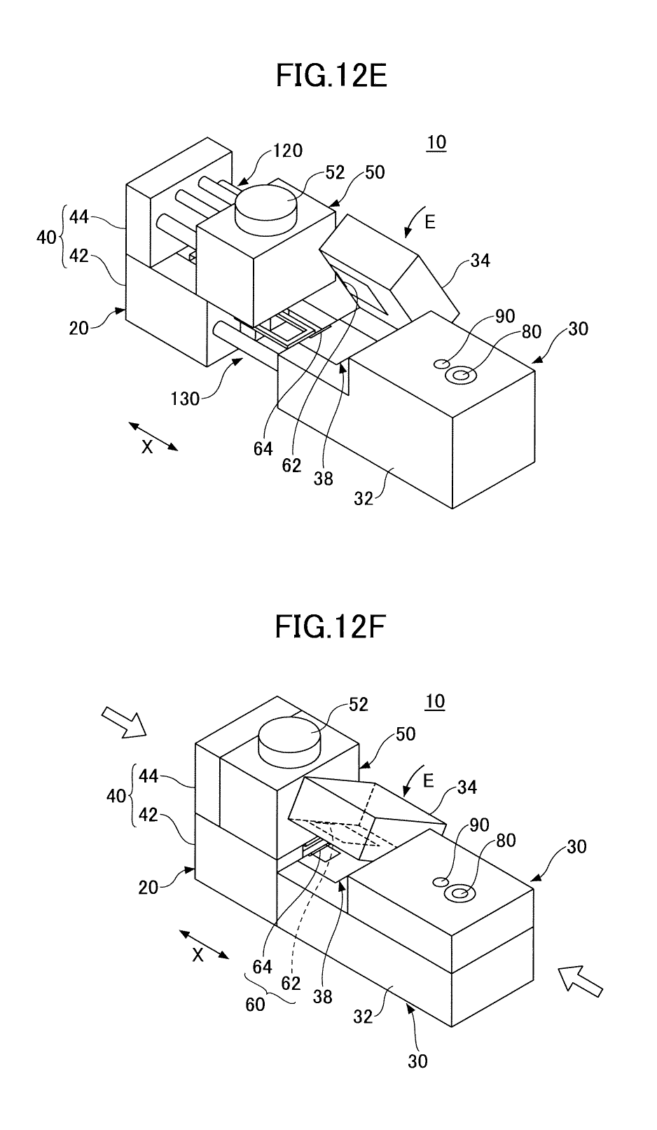

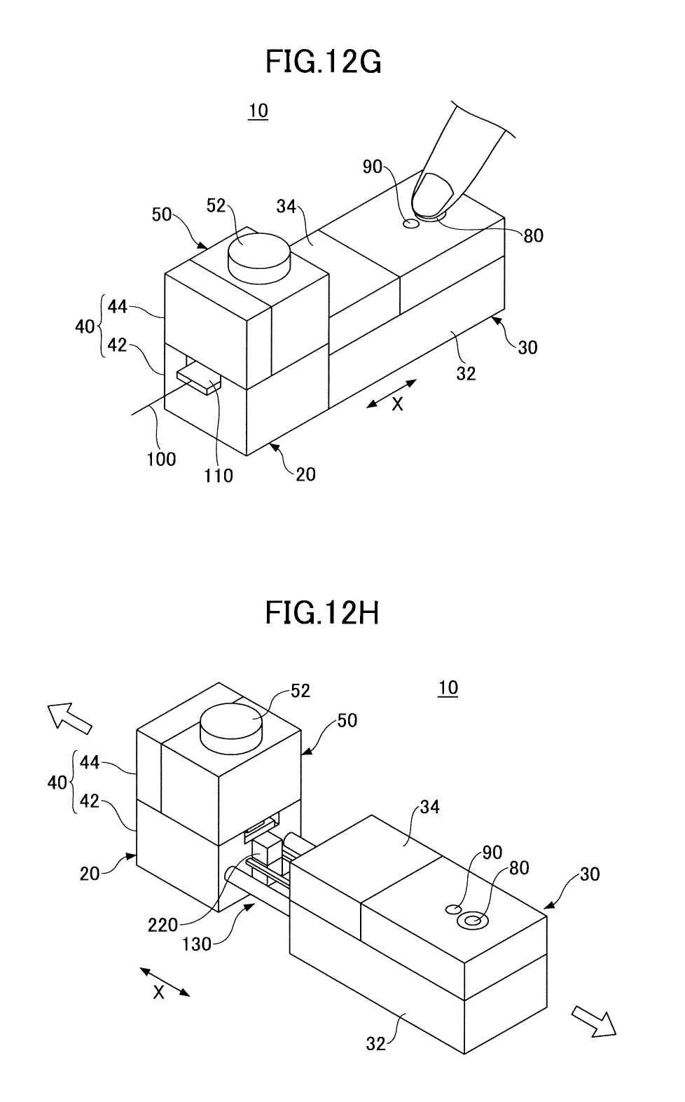

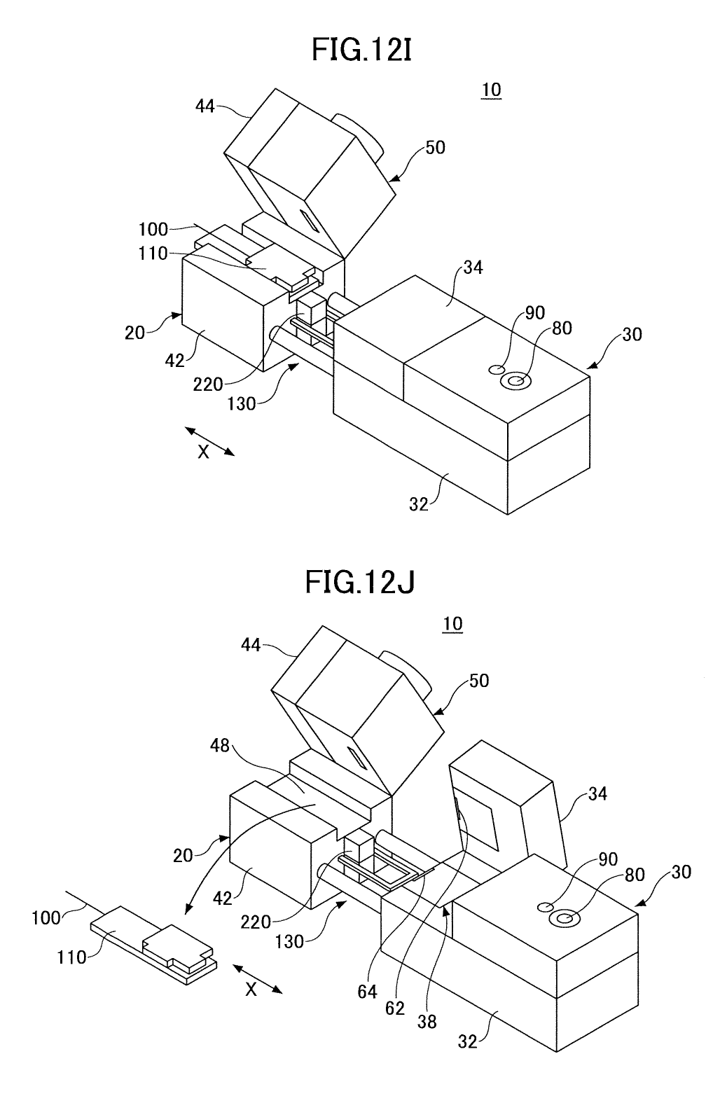

Steps 1 to 10 are explained with reference to FIG. 12A to FIG. 12J. FIG. 12A to FIG. 12D show step 1 to step 4 which are the steps of cutting the optical fiber and FIG. 12E to FIG. 12J show step 5 to step 10 which are the steps of removing the coating material.

(Step 1) As shown in FIG. 12A, the optical fiber cutter/coating material remover apparatus 10 in which the optical fiber cutter unit 20 and the coating material remover unit 30 are integrally formed is prepared.

(Step 2) As shown in FIG. 12B, the optical fiber cutter unit 20 is slid along the guide members 132 in the X-direction with respect to the coating material remover unit 30 so that the optical fiber cutter unit 20 and the coating material remover unit 30 are apart from each other. Then, the upper holder 44 of the holder supporting unit 40 is rotated backward (in a direction B) to expose the concave portion 48 of the lower holder 42. Similarly, the cover member 34 of the coating material remover unit 30 may also be rotated backward to open the coating material remover 38 formed at the upper surface of the housing 32. At this state, the optical fiber holder 110 is mounted on the concave portion 48 of the lower holder 42. The multi-core optical fiber 100 is previously housed in the optical fiber holder 110 (see FIG. 2B and FIG. 2C).

(Step 3) As shown in FIG. 12C, the upper holder 44 of the holder supporting unit 40 is rotated forward to insert the optical fiber holder 110 mounted on the concave portion 48 of the lower holder 42. At this time, the optical fiber cutter mechanism 50 is moved while being guided by the guide mechanism 120 such that the cutter for optical fiber 140 is positioned above the optical fiber support mechanism 220 (see FIG. 5). At the optical fiber support mechanism 220, the movable support member 222 is pushed by the spring force of the torsion spring 228 so that the contacting surface 224 directs upward to face the blade 145 of the cutter for optical fiber 140 (see FIG. 4A).

(Step 4) As shown in FIG. 12D, the pushing operation unit 52 of the optical fiber cutter mechanism 50 is pushed downward. With this, the pushing operation unit 52 is pushed downward to move the elevating member 180 downward as well as the optical fiber pressing member 170 and the collar portion 151 of the cutter support member 150 are pushed downward. Thus, the cutter support member 150 provided inside the optical fiber pressing member 170 also moves downward (see FIG. 7, FIG. 9A and FIG. 9B).

When the pushing operation unit 52 is further pushed downward while the lower end 172 of the optical fiber pressing member 170 contacting the upper surface of the multi-core optical fiber 100, the cutter support member 150 moves downward to have the cutter for optical fiber 140 cut into the multi-core optical fiber 100 (see FIG. 9C and FIG. 9D).

With this, the blade 145 of the cutter for optical fiber 140 is protruded downward from the guide hole 174 of the optical fiber pressing member 170 to cut the end portion of the multi-core optical fiber 100 at the first predetermined length from the end surface of the optical fiber holder 110 held by the lower end 172 of the optical fiber pressing member 170 between the contacting surface 224 of the movable support member 222 (see FIG. 7, FIG. 9C and FIG. 9D).

(Step 5) As shown in FIG. 12E, the cover member 34 of the coating material remover unit 30 is rotated toward the housing 32 side (direction E). At this time, the cover member 34 of the coating material remover unit 30 becomes a state to be inclined with respect to the upper surface of the housing 32 about 45° from a vertical position (or closed position) and the left side surface faces the right side surface of the optical fiber cutter mechanism 50.

(Step 6) As shown in FIG. 12F, the optical fiber cutter unit 20 and the coating material remover unit 30 are slid to be closer with each other. At this time, the multi-core optical fiber 100 and the optical fiber holder 110 are kept held by the holder supporting unit 40 of the optical fiber cutter unit 20. Then, with this state, the optical fiber cutter unit 20 and the coating material remover unit 30 are slid to be closer with each other. At this time, as the cover member 34 is half opened with respect to the housing 32 (rotated in the backward direction), the end portion of the multi-core optical fiber 100 exposed from the end surface of the optical fiber holder 110 is inserted between the upper cutter for coating material 62 and the lower cutter for coating material 64 of the coating material cutter mechanism 60 provided at the coating material remover unit 30.

Further at this time, fragmentation (not shown in the drawings) of the end portion of the cut optical fiber 100 may be left on the contacting surface 224 of the movable support member 222 of the optical fiber support mechanism 220, the fragmentation can be automatically removed through an opening (not shown in the drawings) below the optical fiber cutter unit 20 as the contacting surface 224 of the movable support member 222 becomes inclined state in accordance with the above sliding operation.

(Step 7) As shown in FIG. 12G, the cover member 34 of the coating material remover unit 30 is rotated to be closed (direction E) so that the coating material remover 38 of the housing 32 is covered. With this, in the coating material cutter mechanism 60, the blade 62a of the upper cutter for coating material 62 is cut into the upper side of the coating materials 107 and 108 of the core-wire fibers 101 to 104 and the blade 64a of the lower cutter for coating material 64 is cut into the lower side of the coating materials 107 and 108 of the core-wire fibers 101 to 104 (see FIG. 3C).

Then, the operation switch 80 of the heater unit 70 provided at the upper surface of the housing 32 of the coating material remover unit 30 is switched on. With this, the heater temperature control unit 240 starts supplying power to the heater unit 70 (ceramics heater 247) to heat the coating material remover 38 around the coating material cutter mechanism 60. The heating temperature and the heating period of the heater unit 70 are set to be arbitrary values by the time setting trimmer 72 and the temperature setting trimmer 74. Then, the indicating lamp 90 flashes a red light when the power is started to be supplied to the heater unit 70 and then flashes a green light in accordance with the maintenance of the temperature and the change of the temperature. With this structure, an operator or the like can know the change of the temperatures.

(Step 8) As shown in FIG. 12H, when the temperature of the heater unit 70 reaches the predetermined set temperature, for example, the color of the indicating lamp 90 is changed to green. This means that it is possible to cut the coating materials 107 and 108 of the multi-core optical fiber 100 by the heat of the heater unit 70. Then, after the indicating lamp 90 is changed to emit a green light, the optical fiber cutter unit 20 and the coating material remover unit 30 are slid to be apart from each other. At this time, the multi-core optical fiber 100 and the optical fiber holder 110 are kept held by the holder supporting unit 40 of the optical fiber cutter unit 20.

Thus, the multi-core optical fiber 100 is pulled out from the coating material cutter mechanism 60 while the blade 62a of the upper cutter for coating material 62 and the blade 64a of the lower cutter for coating material 64 are kept being cut into the upper and lower surfaces of the coating materials 107 and 108 of the multi-core optical fiber 100.

Thus, the front end side of the coating materials 107 and 108 of the multi-core optical fiber 100 are torn apart from the position into which the blade 62a of the upper cutter for coating material 62 and the blade 64a of the lower cutter for coating material 64 are cut. Therefore, the coating materials 107 and 108 of the second predetermined length of the end portion of the multi-core optical fiber 100 exposed from the end surface of the optical fiber holder 110 is removed so that the core-wire fibers 101 to 104, the clads 105 and the coating materials 106 are exposed.

(Step 9) As shown in FIG. 12I, the upper holder 44 of the holder supporting unit 40 is rotated backward (direction B) to open the concave portion 48 of the lower holder 42. At this time, the optical fiber cutter mechanism 50 connected to the upper holder 44 is also rotated so that the entirety of the concave portion 48 of the lower holder 42 is opened.

(Step 10) Then, as shown in FIG. 12J, the optical fiber holder 110 mounted on the concave portion 48 is released. Subsequently, the cover member 34 is also rotated backward (open direction) to open the coating material remover 38. Thereafter, fragments generated by the step of cutting the optical fiber and the step of removing the coating material are removed by blowing air or the like. With this, the step of cutting the optical fiber and the step of removing the coating material are finished.

Although in the above embodiment, an example in which the optical fiber cutter unit 20 is configured to move with respect to the coating material remover unit 30 is explained, the coating material remover unit 30 may be configured to move with respect to the optical fiber cutter unit 20, or both of the optical fiber cutter unit 20 and the coating material remover unit 30 may be configured to move with respect to with each other.

As described above, as the optical fiber cutter/coating material remover apparatus 10 has a structure in which the optical fiber cutter unit 20 and the coating material remover unit 30 are integrally formed, there is no fear to forget to bring or prepare either of the optical fiber cutter unit 20 and the coating material remover unit 30. Further, cutting of an end surface of an optical fiber and removing of a coating material can be continuously performed so that the working efficiency is improved.

According to the embodiment, as the optical fiber cutter unit and the coating material remover unit are connected with each other, the step of cutting the end surface of the multi-core optical fiber and the step of cutting and removing the coating material can be continuously performed by first cutting the multi-core optical fiber protruded from the end surface of the optical fiber holder by the optical fiber cutter unit at a predetermined length, and subsequently and continuously cutting the surface of the plural coating materials at a state that the holder supporting unit is in contact with the coating material remover unit which presses the coating materials by the coating material remover unit. Thus, the operation for connecting the multi-core optical fiber can be efficiently performed within a short period.

Although a preferred embodiment of the optical fiber cutter/coating material remover apparatus and the method of cutting an optical fiber and removing a coating material has been specifically illustrated and described, it is to be understood that minor modifications may be made therein without departing from the spirit and scope of the invention as defined by the claims.

The present invention is not limited to the specifically disclosed embodiments, and variations and modifications may be made without departing from the scope of the present invention.

The present application is based on Japanese Priority Application No. 2012-64509 filed on Mar. 21, 2012, the entire contents of which are hereby incorporated by reference.

What is claimed is:

1. An optical fiber cutter/coating material remover apparatus comprising:
an optical fiber cutter unit which cuts an end portion of a multi-core optical fiber held by an optical fiber holder to be a first predetermined length;
a coating material remover unit which cuts a surface of a coating material of the multi-core optical fiber at a second predetermined length from the end portion to expose a core-wire fiber inserted in the coating material for the second predetermined length;
a connecting portion which slidably connects the optical fiber cutter unit to the coating material remover unit with respect to the coating material remover unit,
the optical fiber cutter/coating material remover apparatus being configured such that
the end portion of the multi-core optical fiber is cut while the optical fiber cutter unit is apart from the coating material remover unit,
the cut end portion of the multi-core optical fiber is inserted into the coating material remover unit by sliding the optical fiber cutter unit or the coating material remover unit so that the optical fiber cutter unit and the coating material remover unit are in contact with each other, and then
the coating material is removed by sliding the optical fiber cutter unit or the coating material remover unit so that the optical fiber cutter unit is apart from the coating material remover unit.

2. The optical fiber cutter/coating material remover apparatus according to claim 1,
wherein the optical fiber cutter unit includes
a holder supporting unit which supports the optical fiber holder, and
an optical fiber cutter mechanism which cuts the end portion of the multi-core optical fiber protruded from the optical fiber holder supported by the holder supporting unit,
the optical fiber cutter mechanism including
an optical fiber pressing member which presses the end portion of the multi-core optical fiber exposed from the optical fiber holder from an upper side by an external pushing operation, and
a cutter for optical fiber which cuts the end portion of the multi-core optical fiber pressed by the optical fiber pressing member at the second predetermined length from the end surface of the optical fiber holder.

3. The optical fiber cutter/coating material remover apparatus according to claim 2,
wherein the cutter for optical fiber is movably provided with respect to the optical fiber pressing member in the vertical direction, and
the optical fiber cutter mechanism includes
a pushing operation unit which is applied with the pushing operation in the vertical direction,
a first elastic member which pushes the pushing operation unit to an initial position before a pushing operation,
an elevating member which slides in the vertical direction by the pushing operation of the pushing operation unit, and
a second elastic member which absorbs the relative displacement of the optical fiber pressing member and the cutter for optical fiber in accordance with the sliding operation of the elevating member.

4. The optical fiber cutter/coating material remover apparatus according to claim 2,
wherein the optical fiber cutter unit includes a movable support member which supports the multi-core optical fiber from a lower side which is an opposing side of the cutter for optical fiber when cutting the end portion of the multi-core optical fiber,
the movable support member being configured to take a withdrawal position at which the movable support member does not intervene with the sliding of the optical fiber cutter unit or the coating material remover unit when the optical fiber cutter unit and the coating material remover unit become in contact with each other.

5. The optical fiber cutter/coating material remover apparatus according to claim 1,
wherein the coating material remover unit includes
an upper cutter for coating material for cutting the coating material from an upper side, and
a lower cutter for coating material for cutting the coating material from a lower side.

6. The optical fiber cutter/coating material remover apparatus according to claim 5,
wherein the upper cutter for coating material is provided at a cover member of the coating material remover unit, and
the lower cutter for coating material is provided at a housing of the coating material remover unit,
the optical fiber cutter/coating material remover apparatus being configured such that
the upper cutter for coating material and the lower cutter for coating material cut the coating material from upper and lower sides by closing the cover member after the cut end portion of the multi-core optical fiber is inserted into the coating material remover unit.

7. The optical fiber cutter/coating material remover apparatus according to claim 1,
wherein the connecting portion includes a guide member held between the optical fiber cutter unit and the coating material remover unit and the optical fiber cutter unit or the coating material remover unit is slidably guided by the guide member.

8. A method of cutting an optical fiber and removing a coating material, comprising:
a first step in which an optical fiber holder holding an optical fiber is held by an optical fiber cutter unit;
a second step in which the multi-core optical fiber exposed from an end surface of the optical fiber cutter unit is cut to be a first predetermined length by moving a cutter for optical fiber by pushing a pushing operation unit of the optical fiber cutter unit;
a third step in which the cut end portion of the multi-core optical fiber is inserted into a coating material remover unit by sliding the optical fiber cutter unit or the coating material remover unit so that the optical fiber cutter unit and the coating material remover unit are in contact with each other;
a fourth step in which a surface of the coating material is cut at a second predetermined length from the cut end portion by a cutter for coating material by closing a cover member of the coating material remover unit; and
a fifth step in which the optical fiber cutter unit or the coating material remover unit is moved to be apart from each other while holding the optical fiber holder to remove the coating material.
